(19) United States
(12) Patent Application Publication
(10) Pub. No.: US 2006/0085260 A1
(43) Pub. Date: Apr. 20, 2006

(54) Coupon service system

(75) Inventor: Junichi Yamagishi, Higashi-Nihonbashi (JP)

Correspondence Address: JORDAN AND HAMBURG LLP, 122 EAST 42ND STREET, SUITE 4000, NEW YORK, NY, 10168, US

(73) Assignee: Nihon Unica Corporation, Chuo-ku (JP)

(21) Appl. No.: 11/255,224

(22) Filed: Oct. 19, 2005

(30) Foreign Application Priority Data
Oct. 20, 2004 (JP) 2004-305220

(51) Int. Cl. G06Q 30/00

(52) U.S. Cl. 705/14

(57) ABSTRACT

A coupon service system is capable of reducing time and expenses needed for market research, making a correct and sure marketing plan, and providing customers with services that match their respective needs. The coupon service system includes a store terminal provided with a reader. When a cellular phone is brought into a read area of the reader, the reader reads a coupon stored in the cellular phone and determines whether or not the coupon is valid. If the coupon is valid, the reader provides the user of the cellular phone with a service corresponding to the coupon and transmits data related to the user to a management server. The management server stores the data in a customer database.

### BACKGROUND OF THE INVENTION

1. Field of the Invention

The present invention relates to a coupon service system capable of reducing time and expenses needed for market research, making a correct and sure marketing plan, and providing customers with services that match their respective needs.

2. Description of Related Art

According to a conventional marketing system, a seller frequently uses paper media such as leaflets to distribute commodity information to latent customers and carries out market research by analyzing data related to customers who actually come to stores or purchase commodities.

The conventional marketing system employing paper media is slow in providing customers with commodity information. In addition, market research based on the conventional marketing system requires much expense in time and labor. The conventional marketing system is unable to gather information about each customer who visits a store or purchases commodities, and therefore, is unable to provide customers with services that match their respective needs. The conventional marketing system is unable to properly analyze the effect of marketing, and therefore, is unable to make a correct and sure marketing plan.

The conventional marketing system is disclosed in, for example, Japanese Unexamined Patent Application Publication No. 2004-280842.

### SUMMARY OF THE INVENTION

An object of the present invention is to provide a coupon service system capable of reducing time and expenses needed for market research, making a correct and sure marketing plan, and providing customers with services that match their respective needs.

In order to accomplish the object, an aspect of the present invention provides a coupon service system including a communication terminal operated by a user, a store terminal arranged in a store the user visits, and a management server. The management server has a customer database to store data about the user. In response to a coupon issue instruction from the store terminal, the management server transmits a coupon usable in the store to the communication terminal through an electric communication circuit. When the communication terminal is brought into a read area of the store terminal, the store terminal reads the coupon stored in the communication terminal and determines whether or not the coupon is valid. If the coupon is valid, the store terminal provides the user of the communication terminal with a service corresponding to the coupon and transmits customer data about the user to the management server. The management server stores the transmitted customer data in the customer database.

The coupon service system of this aspect provides a user with a coupon through an electric communication circuit. Through the same communication circuit, the system can speedily provide the user with commodity information and conduct market research at low cost.

The coupon service system of the above-mentioned aspect stores information about each customer in the customer database. By retrieving information from the customer database, the system can provide customers with services that match their respective needs.

The coupon service system of the above-mentioned aspect refers to the customer database to analyze the effect of coupons given to customers. According to a result of the analysis, a correct and sure marketing plan will be prepared.

### BRIEF DESCRIPTION OF THE DRAWINGS

FIG. 1 is a general view showing a coupon service system according to an embodiment of the present invention;

FIG. 2 is a flowchart showing a registration process according to an embodiment of the present invention;

FIG. 3 is a view showing an example of a registration screen according to an embodiment of the present invention;

FIG. 4 is a flowchart showing a coupon preparation process according to an embodiment of the present invention;

FIG. 5 is a view showing an example of a coupon preparation screen according to an embodiment of the present invention; and

FIG. 6 is a flowchart showing a coupon service providing process according to an embodiment of the present invention.

### DETAILED DESCRIPTION OF EMBODIMENTS

A coupon service system according to an embodiment of the present invention will be explained in detail with reference to the drawings.

[Configuration of Coupon Service System]

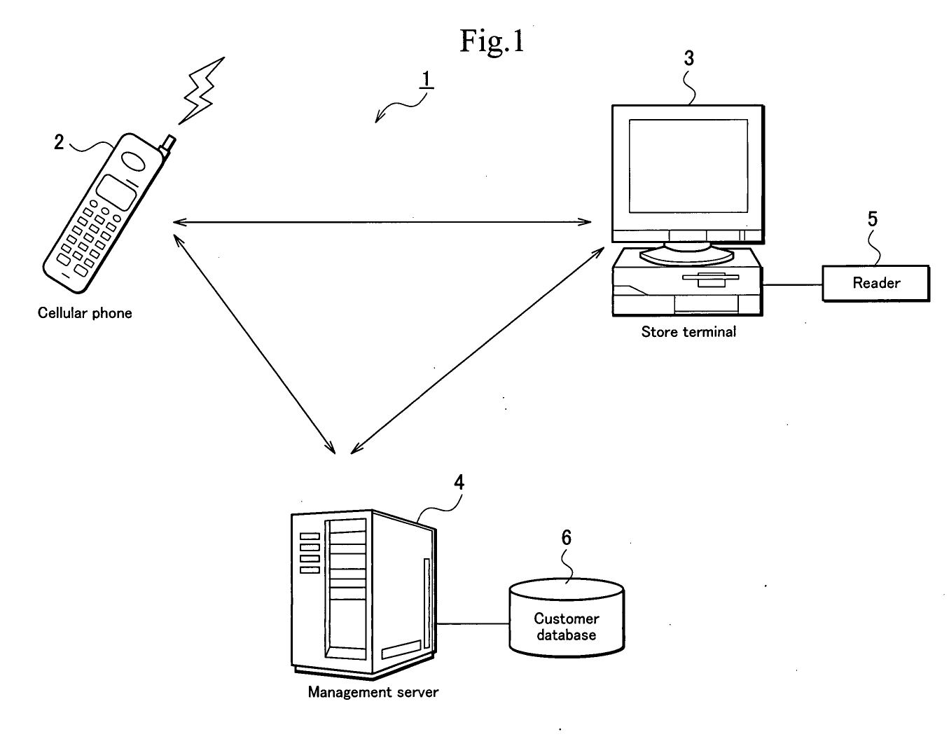

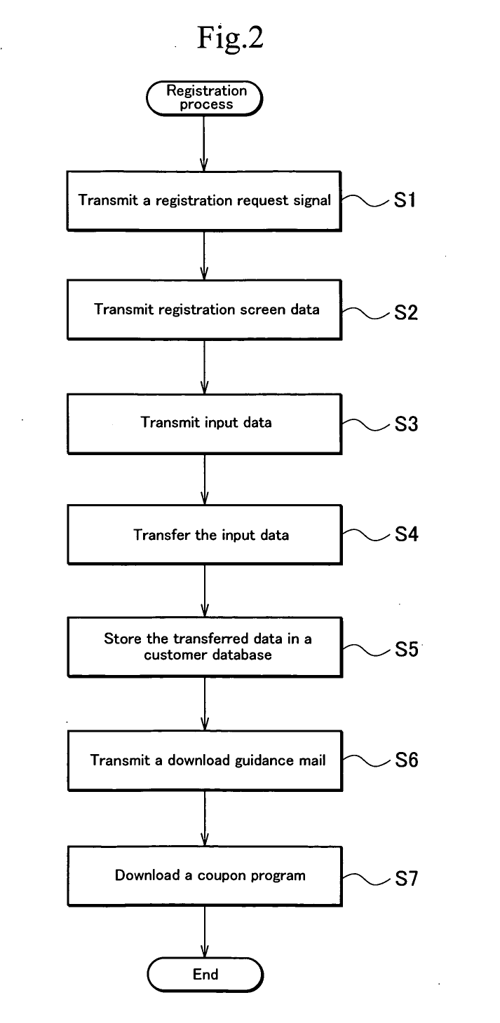

FIG. 1 shows the coupon service system 1 according to the embodiment of the present invention. The system 1 includes a cellular phone 2 carried by a user, a store terminal 3 arranged in a store, and a management server 4 arranged on a management side that manages the system 1. These components of the system 1 can communicate with one another through electric communication circuits. The store terminal 3 has a reader 5 that communicates with the cellular phone 2 during a coupon service providing process to be explained later. The management server 4 has a customer database (DB) 6 to store customer data about users who use the system 1. The system 1 executes a registration process, a coupon issuing process, and the coupon service providing process. With these processes, the system 1 can reduce time and cost required for market research, make a correct and sure marketing plan, and provide each customer with a service that matches the needs of the customer. The registration process, coupon issuing process, and coupon service providing process conducted by the coupon service system 1 will be explained with reference to the flowcharts of FIGS. 2, 4, and 6.

[Registration Process]

With reference to the flowchart of FIG. 2, the registration process executed by the coupon service system 1 will be explained. The registration process registers data about a user who uses the system 1.

The flowchart of FIG. 2 starts at step S1 when the user connects the cellular phone 2 to the store terminal 3 through an electric communication circuit.

In step S1, the user carries out a registration operation on the cellular phone 2, which transmits a registration request signal to the store terminal 3. This completes step S1, and the registration process proceeds to step S2.

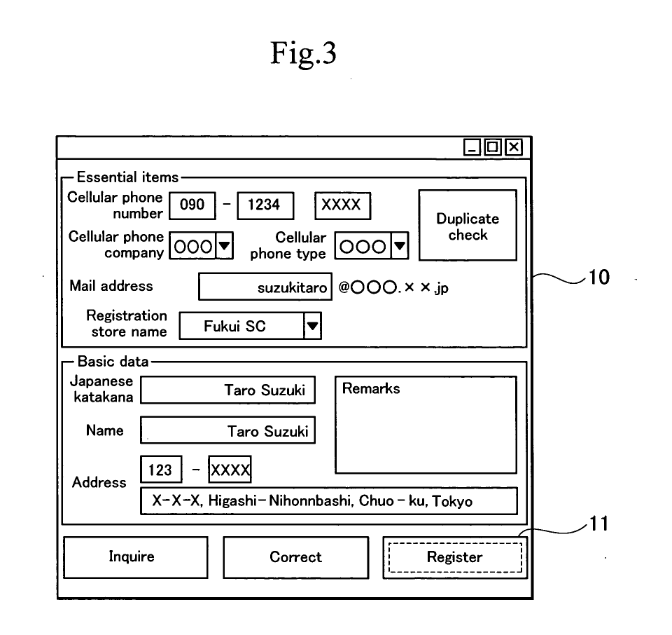

In step S2, the store terminal 3 receives the registration request signal from the cellular phone 2 and transmits a registration screen 10 shown in FIG. 3 to the cellular phone 2. The registration screen 10 is used to register customer information such as a user name, a user address, the telephone number of the cellular phone 2, an electronic mail address, and the name of the store where a coupon is used. This completes step S2, and the registration process proceeds to step S3.

In step S3, the cellular phone 2 displays the registration screen 10, and the user enters data into the registration screen 10 with the use of buttons. When the user pushes a registration button 11 in the registration screen 10, the entered data is transmitted to the store terminal 3. This completes step S3, and the registration process proceeds to step S4.

In step S4, the store terminal 3 receives the entered data from the cellular phone 2 and transfers the same to the management server 4. This completes step S4, and the registration process proceeds to step S5.

In step S5, the management server 4 receives the transferred data from the store terminal 3 and stores the same in the customer database 6. This completes step S5, and the registration process proceeds to step S6.

In step S6, the management server 4 refers to the customer database 6 and transmits a download guidance mail to the cellular phone 2 of the user. The download guidance mail asks the user to download a coupon program that is necessary when using a coupon. This completes step S6, and the registration process proceeds to step S7.

In step S7, the cellular phone 2 receives the download guidance mail, and according to the mail, the user instructs the cellular phone 2 to download the coupon program. The cellular phone 2 downloads the coupon program from the management server 4. The user installs the downloaded coupon program in the cellular phone 2. This completes step S7, and the registration process ends.

[Coupon Issuing Process]

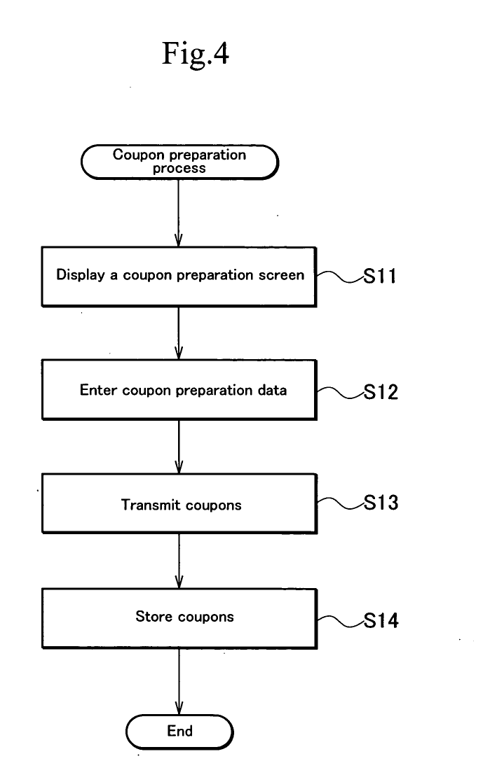

The coupon issuing process executed by the coupon service system 1 will be explained With reference to the flowchart of FIG. 4. This process issues coupons (service coupons) through electric communication circuits to users who made registration through the registration process.

The flowchart of FIG. 4 starts at step S11 when a seller activates a coupon preparing program on the store terminal 3.

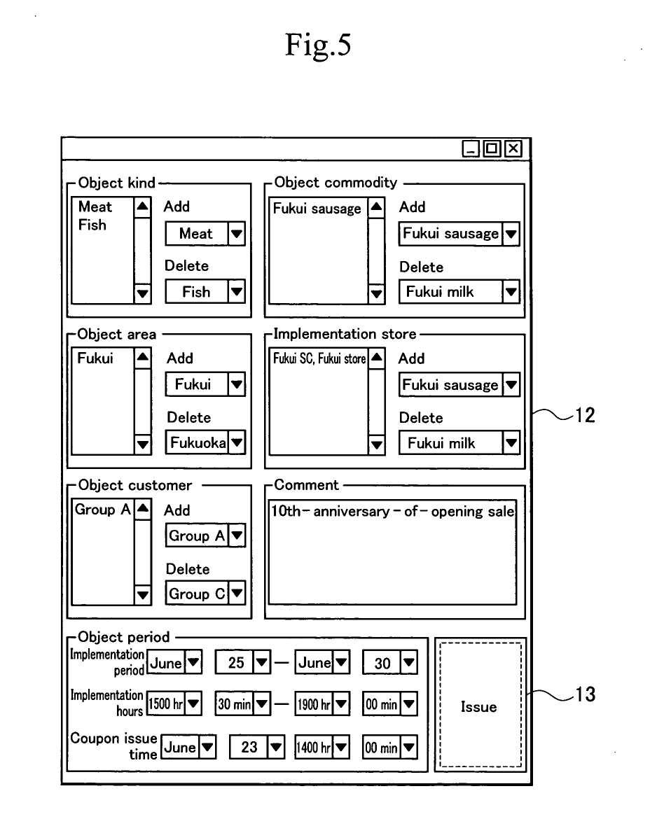

In step S11, the store terminal 3 displays a coupon preparation screen 12 shown in FIG. 5. The screen 12 is used to enter data such as the types and names of commodities (object commodities) for which coupons are issued, an area (object area) to which the coupons are issued, stores (implementation stores) where the coupons are usable, customers (object customers) who are authorized to use the coupons, a period (implementation period and time) during which the coupons are usable, and a coupon issuing period (coupon delivery period). This completes step S11, and the coupon issuing process advances to step S12.

In step S12, the store terminal 3 transmits coupon preparation data to the management server 4 when an issuance button 13 on the coupon preparation screen 12 is pushed. The coupon preparation data includes data related to the types and names of object commodities, object area, implementation stores, object customers, implementation period and time, and coupon delivery period entered on the coupon preparation screen 12. This completes step S12, and the coupon issuing process advances to step S13.

In step S13, the management server 4 receives the coupon preparation data from the store terminal 3, retrieves, according to the coupon preparation data, users to whom coupons are delivered from the customer database 6, and transmits coupons with electronic mails to the cellular phones of the corresponding users. This completes step S13, and the coupon issuing process advances to step S14.

In step S14, the cellular phones receive the coupons from the management server 4 and store the same. This completes step S14, and the coupon issuing process ends.

[Coupon Service Providing Process]

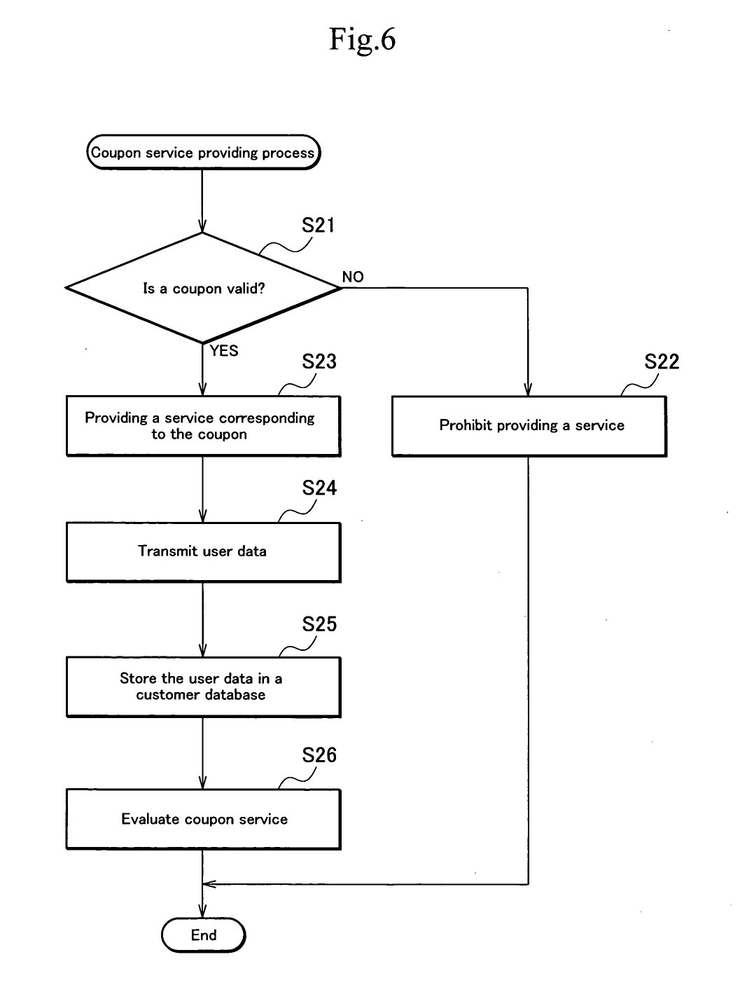

The coupon service providing process executed by the coupon service system 1 will be explained with reference to the flowchart of FIG. 6. This process provides a user with a service corresponding to a coupon issued by the coupon issuing process.

The flowchart of FIG. 6 starts at step S21 when the user of the cellular phone 2 goes to the store where the coupon is usable, takes the cellular phone 2 into a communication range of the reader 5 installed in the store, and activates the coupon program installed in the cellular phone 2.

In step S21, the reader 5 communicates with the cellular phone 2 and determines whether or not the coupon stored in the cellular phone 2 is valid. If it is determined that the coupon is not invalid, the reader 5 outputs, in step S22, a message showing that the coupon is not usable, prohibits services from being provided, and terminates the coupon service providing process. If it is determined that the coupon is valid, the reader 5 provides, in step S23, the user of the cellular phone 2 with a service corresponding to the coupon stored in the cellular phone 2. Thereafter, the coupon service providing process proceeds to step S24.

In step S24, the reader 5 transmits data related to the user who has used the coupon to the store terminal 3, which transfers the data to the management server 4. This completes step S24, and the coupon service providing process proceeds to step S25.

In step S25, the management server 4 receives the user data from the store terminal 3 and stores the same in the customer database 6. This completes step S25, and the coupon service providing process proceeds to step S26.

In step S26, the seller at the store terminal 3 accesses the customer database 6 through the store terminal 3, refers to customer data stored in the customer database 6, evaluates the coupon service, and carries out market research, and the like. This completes step S26, and the coupon service providing process ends.

In this way, the coupon service system 1 according to the embodiment of the present invention includes the store terminal 3 provided with the reader 5. When the cellular phone 2 is brought into a read area of the reader 5, the reader 5 reads data related to a coupon stored in the cellular phone 2 and determines whether or not the coupon is valid. If the coupon is valid, the reader 5 provides the user of the cellular phone 2 with a service corresponding to the coupon and transmits data related to the user to the management server 4. The management server 4 stores the data in the customer database 6.

The coupon service system 1 can speedily provide coupons and commodity information to users through electric communication circuits and can reduce expenses for market research. The customer database 6 stores data about users, and a seller may refer to the customer database 6 to provide users with services that match the needs of the users. The seller may refer to the customer database 6 and analyze the effect of coupons given to users, to make a correct and sure marketing plan.

According to the coupon service system 1, the store terminal 3 sends a coupon issue instruction to the management server 4. Based on the coupon issue instruction, the management server 4 selects users to whom coupons are issued from among users recorded in the customer database 6. The system 1 can deliver coupons to users according to the needs of the users.

According to the coupon service system 1, the store terminal 3 sends a coupon issue instruction to the management server 4. Based on the coupon issue instruction, the management server 4 determines a period during which coupons are issued and an area where users to receive coupons reside. A seller can refer to the customer database 6 to conduct market research for a specific period and area. It may omit one of the period during which coupons are issued and the area where users to receive coupons reside, and determine the other of the period and the area.

Although the present invention has been explained with reference to the embodiments, it must be understood that the embodiments, descriptions, and drawings disclosed herein are not intended to limit the present invention and that other embodiments, modifications, or implementations that may occur to persons skilled in the art from the teachings of the present invention also fall in the scope of the present invention.

The user registration process mentioned above may be carried out with a written application form. Namely, a store gives a blank application form to a user, and the user fills the form and returns the same to the store.

What is claimed is:

1. A coupon service system comprising:
a communication terminal operated by a user;
a store terminal capable of sending a coupon issue instruction arranged in a store the user visits; and
a management server having a customer database to store data about the user, the management server transmitting, in response to the coupon issue instruction from the store terminal, a coupon usable in the store to the communication terminal through an electric communication circuit, wherein:
when the communication terminal is brought into a read area of the store terminal, the store terminal reads the coupon stored in the communication terminal and determines whether or not the coupon is valid;
if the coupon is valid, the store terminal provides the user of the communication terminal with a service corresponding to the coupon and transmits data about the user to the management server; and
the management server stores the transmitted data in the customer database.

2. The system of claim 1, wherein:
based on the coupon issue instruction from the store terminal, the management server selects users to whom coupons are issued from among users recorded in the customer database.

3. The system of claim 1, wherein:
based on the coupon issue instruction from the store terminal, the management server determines at least one of a period during which coupons are issued and an area where users to receive coupons reside.

4. The system of claim 2, wherein:
based on the coupon issue instruction from the store terminal, the management server determines at least one of a period during which coupons are issued and an area where users to receive coupons reside.
